(19) United States
(12) Patent Application Publication
(10) Pub. No.: US 2015/0088671 A1
(43) Pub. Date: Mar. 26, 2015

(54) PROVIDING CUSTOMIZED ENTERTAINMENT BASED ON WAIT TIME

(71) Applicants: Sony Network Entertainment International LLC, Los Angeles, CA (US); Sony Corporation, Tokyo (JP)

(72) Inventors: True Xiong, San Diego, CA (US); Charles McCoy, Coronado, CA (US)

(73) Assignee: Sony Corporation, Tokyo (JP)

(21) Appl. No.: 14/032,625

(22) Filed: Sep. 20, 2013

(51) Int. Cl. G06Q 30/00; G06Q 50/12

(52) U.S. Cl. CPC G06Q 30/016; G06Q 50/12
USPC 705/15; 705/304

(57) ABSTRACT

Systems and methods are disclosed for providing an entertainment consumption experience based at least in part on a determined wait time for ordered items. Such may generally also take account of profiles of users awaiting the items. The systems and methods may be employed in any network-enabled system that includes consumer electronic (“CE”) devices (or restaurant-provided or -situated dedicated devices) and an appropriate management system to provide estimates of wait time.

### BACKGROUND

Restaurant food-ordering technology has advanced to the stage where, to a certain extent, patrons can order food from their table using certain devices without the need for a wait staff to take their order. However, even with such advancements, a patron is unaware of the wait time required for their food to be cooked and delivered. Moreover, the wait time can fluctuate given varying restaurant conditions. Such is often a source of patron complaint, which can be detrimental to the success of a restaurant.

### SUMMARY

In systems and methods according to present principles, real-time information is employed in a food ordering system to provide an accurate estimate of wait time for ordered food delivery. In addition, during the wait time, systems and methods provide an entertainment consumption experience based at least in part on the wait time. Such may generally also take account of user profiles. The systems and methods may be employed in any network-enabled system that includes consumer electronic (“CE”) devices (or restaurant-provided or -situated dedicated devices) and an appropriate kitchen management system to provide estimates of wait time.

In one implementation, as a user adds food items using a menu operated by an application on their mobile device or on a dedicated restaurant-provided or -situated device, the expected wait time is displayed. Factors such as a user's profile or unique device ID allow the provision of recommended food or drink items, either from a central server or from a third-party service if a profile from the same includes information enabling such recommendations. The ordered food items reflect the wait time and the same may be updated as items are added or removed. The wait time may be absolute or may be relative to other patrons currently in the restaurant, e.g., “you are next to receive your order”, and so on. Such data points give a clear indication of what a user may expect with regard to wait time.

While a user is waiting for food to be cooked and delivered to their table, the time window can be used to deliver custom-tailored entertainment content to the user, either to the user's personal mobile device or to a communal display, e.g., one provided by the restaurant, visible to all in the user's group. Put another way, the device that plays the media need not be the same used to select the food. In some cases, the custom-tailored entertainment content may be a result of both information from a user profile and real-time user selections.

In one aspect, the invention is directed towards a method of providing tailored content to a customer during a waiting period, including: from an application running on a device, the application associated with a user profile, receiving at a server a selection of a first menu item selected from a menu of an establishment; from a kitchen management system associated with the establishment, receiving a wait time, the wait time corresponding to a time duration for a customer to receive the selected first menu item; selecting at least one digital content item to deliver, the selecting based at least in part on the wait time and the user profile; and delivering the selected digital content item to the device or to a communal device, e.g., by transmitting a signal from the system server to a media server to cause delivery of the selected digital content.

Implementations of the invention may include one or more of the following. The receiving a wait time may include submitting the first menu item to the kitchen management system and receiving a wait time in response to the submission. The kitchen management system may form a part of the server. The method may further include receiving notification of a check-in at the establishment, the check-in associated with the user profile. The notification may be received from a social networking site. The menu displayed on a user interface of the application may be filtered based on the user profile. The device may be a CE device or a dedicated device. The selecting may be further based on a profile associated with the establishment. The method may further include transmitting the received wait time to the device. The method may further include transmitting an updated wait time to the device, as additional information from the kitchen management system is received about a status of the first menu item. At least one additional digital content item may then be selected and delivered, based at least in part on the updated wait time and the user profile. The receiving at a server may include receiving the selection of the first menu item from the device via a near field communications hotspot disposed adjacent the device. The selecting may further be based on a departure time, the departure time entered by the user. The method may further include receiving at the server a selection of a plurality of menu items selected from a menu of an establishment, and the wait time then corresponds to a time duration for both the selected first menu item and the plurality of selected menu items to be received by customers.

In another aspect, the invention is directed towards a non-transitory computer readable medium, including instructions for causing a computing environment to perform the above method.

In yet another aspect, the invention is directed towards a method of determining an establishment for a group of customers to patronize, including: in an application running on a server, receiving a signal from one or more users operating client devices that a user group is to be formed, and forming a data structure representing the group including an identifier from each user in the group, each user in the group having a respective user profile, whereby the group represents users desiring to patronize an establishment together; receiving from the client device of at least one member of user in the group a maximum wait time; and from at least one user profile and from the maximum wait time, determining an establishment for the group the patronize, the establishment having a an establishment wait time less than the maximum wait time, and the establishment consistent with each user profile within the group.

Implementations of the invention may include one or more of the following. The method may further include choosing at least one content item to deliver, to the group, the choosing based at least in part on the wait time and at least one of the user profiles; and delivering the chosen content item to at least one of the client devices of the users in the group, or to a communal device. The method may further include receiving from a plurality of users in the group a maximum wait time, and where the determining an establishment for the group to patronize includes determining an establishment with an establishment wait time less than the least maximum wait time received from the plurality.

In yet another aspect, the invention is directed towards a non-transitory computer readable medium, including instructions for causing a computing environment to perform the above method.

In yet another aspect, the invention is directed towards a method of determining a group of customers and selecting a content item appropriate therefore, including: on an application running on a server, receiving from a plurality of customers a maximum wait time, each customer further associated with a user profile accessible to the application; selecting a group from the plurality, the group having a common maximum wait time, within a wait time tolerance, and a common user profile, within a profile tolerance; and determining an establishment for the group the patronize, the establishment having a wait time less than the common maximum wait time of the group, and the establishment consistent with each user profile within the group.

Implementations of the invention may include one or more of the following. The method may further include choosing at least one content item to deliver to the group, the choosing based at least in part on the common maximum wait time and at least one of the user profiles; and delivering the chosen content item to the group.

In yet another aspect, the invention is directed towards a non-transitory computer readable medium, including instructions for causing a computing environment to perform the above method.

Advantages of the systems and methods according to present principles may include one or more of the following. A user is made aware of ordered food wait time, increasing user satisfaction, and the wait time may be used to deliver tailored or custom media content to users. The systems and methods according to present principles, which create a need for short tailored content, may even spawn series of short films or custom-edited films which can be easily watched in a standard wait time or lunch hour (and certain short films may have different edited versions, capable of being chosen by the user, for minimized violence, language, sexual content, and the like). The systems and methods may provide ways to introduce new content, such as a new singer or songwriter, to a tailored locale. In this way, e.g., a new singer may be showcased at a particular location. The systems and methods may provide intelligent ways to predict food items and content, provide users with data about wait times, and allow tailored content to be delivered in selected time periods.

In general it is noted that people are often in a hurry when they go out to eat. They may be on a lunch break from work and need to get back at a particular time. They may be eating dinner on their way to the theater. Letting people who are in a hurry know what the wait times will be, and how their order choices affect wait times, can enable a less stressful dining experience, and will allow people to avoid accidentally ordering an item having a preparation time inconsistent with the person's available time.

Other advantages will be apparent from the description that follows, including the figures and claims.

### BRIEF DESCRIPTION OF THE DRAWINGS

FIG. 1 is an exemplary depiction of a first implementation according to present principles, in which CE devices and a dedicated device, e.g., for use by patrons without CE devices, are present at a restaurant table for ordering and for content playback.

FIG. 2 is an exemplary depiction of a second implementation according to present principles, similar to that of FIG. 1, but where a system server, or just “server”, is off-site.

FIG. 3 is a flowchart according to an implementation of present principles, illustrating a general method.

FIG. 4 is a sequence diagram according to an implementation of present principles, illustrating a general method.

FIG. 5 is another flowchart according to an implementation of present principles, illustrating in particular bases for tailoring content.

FIG. 6 is another flowchart according to an implementation of present principles, illustrating in particular means for content delivery.

FIG. 7 is another flowchart according to an implementation of present principles, illustrating in particular how menu items may be filtered according to the user dietary restrictions.

FIG. 8 is another flowchart according to an implementation of present principles, illustrating in particular how systems and methods may be employed with health and fitness plans.

FIG. 9 is another flowchart according to an implementation of present principles, illustrating in particular how a user can enter a wait time, and a menu can be filtered based on the same.

FIG. 10 is another flowchart according to an implementation of present principles, illustrating in particular how systems and methods may be employed in restaurant selection.

FIG. 11 is another flowchart according to an implementation of present principles, illustrating in particular how systems and methods may be employed in group creation.

FIG. 12 is another flowchart according to an implementation of present principles, illustrating in particular how the application may guide restaurant selection based on an entered wait time, and how information about patrons and wait times may be employed by restaurant management to more efficiently predict staffing.

FIG. 13 is another flowchart according to an implementation of present principles, illustrating in particular steps which may be employed by an exemplary kitchen management system in calculating a wait time.

FIG. 14 is an exemplary computing environment in which the methods according to present principles may be implemented, including as part of a CE device, dedicated device, communal device, system server, KMS, or other computing devices noted here.

Corresponding reference characters indicate corresponding parts throughout the drawings.

### DETAILED DESCRIPTION

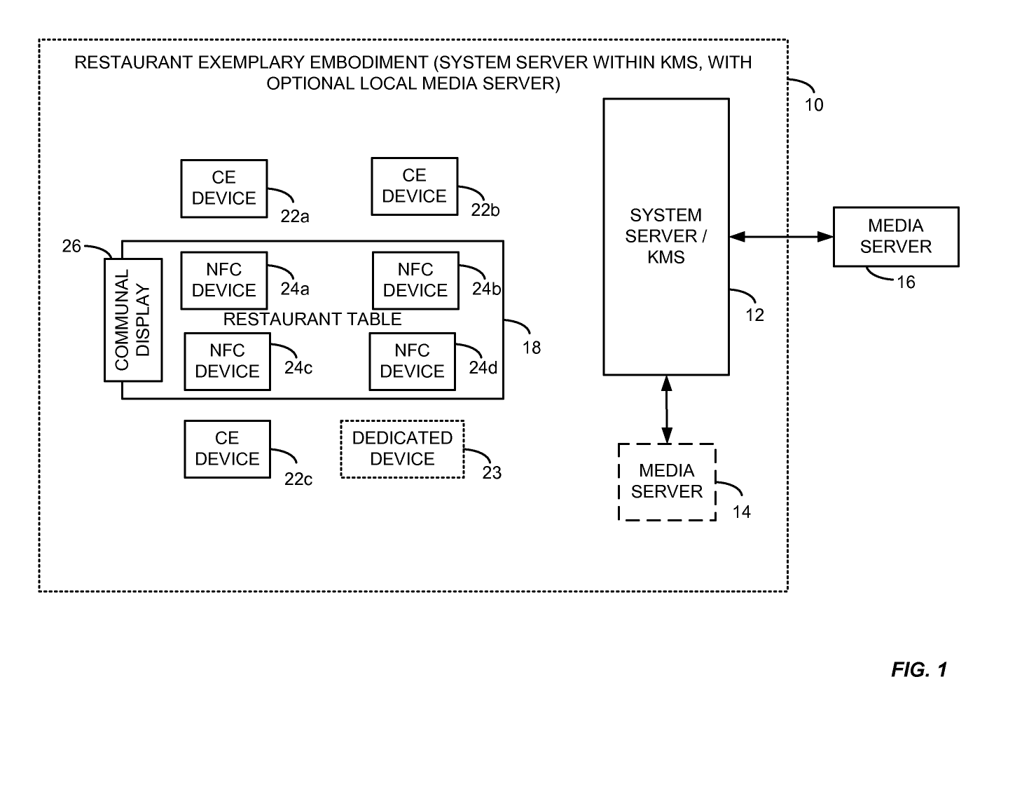

Referring to FIG. 1, a restaurant 10 is depicted with an exemplary table for customers or patrons 18. One or more CE devices 22a-22c are shown around the table to illustrate smart phones that patrons of the restaurant, seated at the restaurant table 18, may carry on their person and which may be enabled to take part in methods and systems according to present principles. Of course, in a given implementation, only one such CE device is required. Moreover, instead of a CE device as provided by a user, the CE device may be a dedicated device 23 provided by the restaurant for the use by a patron, e.g., where the patron does not bring a CE device.

The restaurant table 18 may include one or more near field communications (“NFC”) hotspots 24a-24d. One may be provided at each spot at the table, or a communal hotspot may be provided, e.g., in the center of the table (not shown), for use by any or all devices. The CE devices may use the NFC hotspots or may communicate with the system server (or just a “server”) and/or a kitchen management system (“KMS”) via other methods, e.g., mobile networks, satellite networks, WiFi, and the like. A communal display 26 is illustrated at the table 18, which may be employed for viewing custom-tailored entertainment content, in the case where the CE devices 22a-22c are not themselves used for such purposes. In addition, the communal display 26 may allow for a larger screen, and one that is visible by all patrons at the table 18. A display such as a TV 25 is also illustrated, visible by not only the patrons at table 18 but also by patrons at tables adjacent to and near table 18 (not shown).

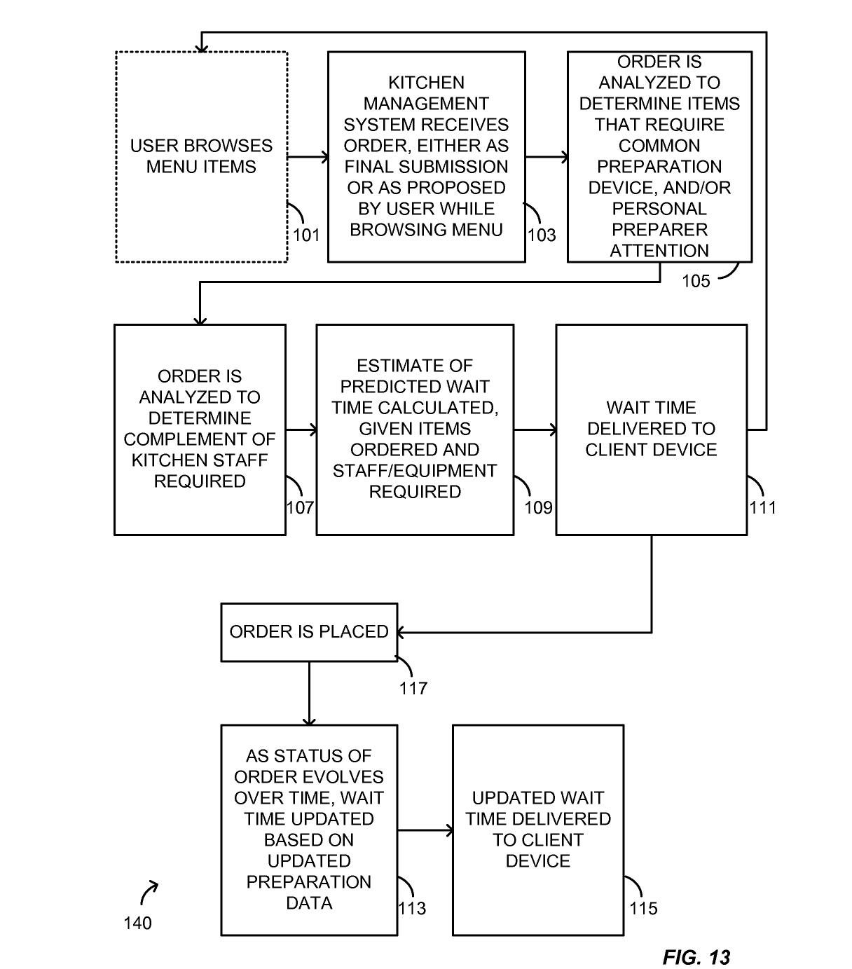

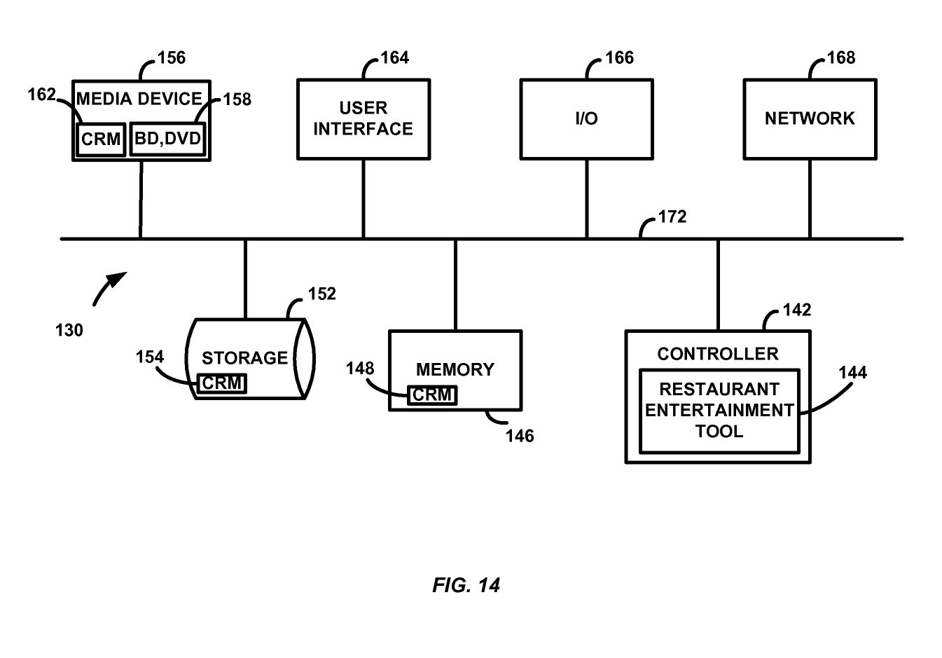

A system server and KMS 12 is illustrated which may provide the functionality noted below, e.g., calculation of wait times for entrées, determination of custom-tailored content, and the like. The custom-tailored content may be delivered from a media server 14 on the premises of the restaurant or from a media server 16, which may be anywhere so long as the same is connected in network communication with the system server/KMS 12. An exemplary method which may be performed by the KMS 12 is described below with respect to the flowchart 140 of FIG. 13.

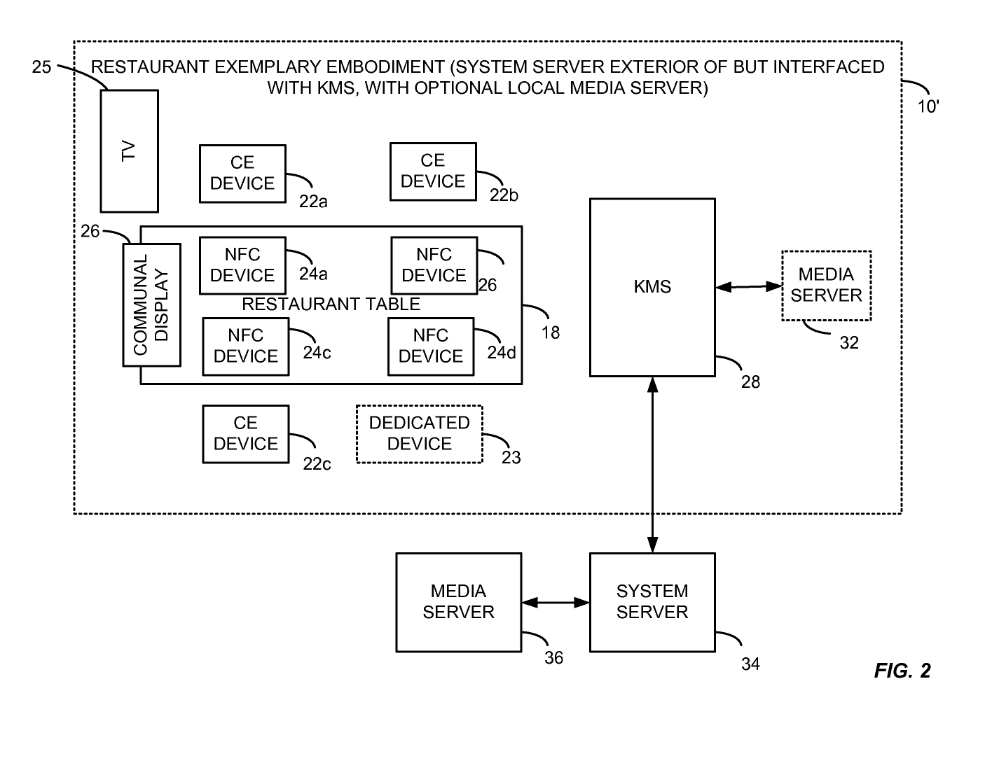

In FIG. 2, an alternative implementation of a restaurant 10′ is shown, in which a KMS 28 interacts with a system server 34, the system server 34 external to the restaurant, e.g., at a location in network communication with the restaurant and KMS 28. The system server 34 communicates with the media server 36 and/or a media server 32, local to the restaurant, through the KMS 28. A local media server, even if not always employed, may be useful in cases where the restaurant network communication link is inoperative. In other implementations, the system server may be separate from the KMS but each located within the establishment, in network communication with a media server, and the same are employed with or without a local media server.

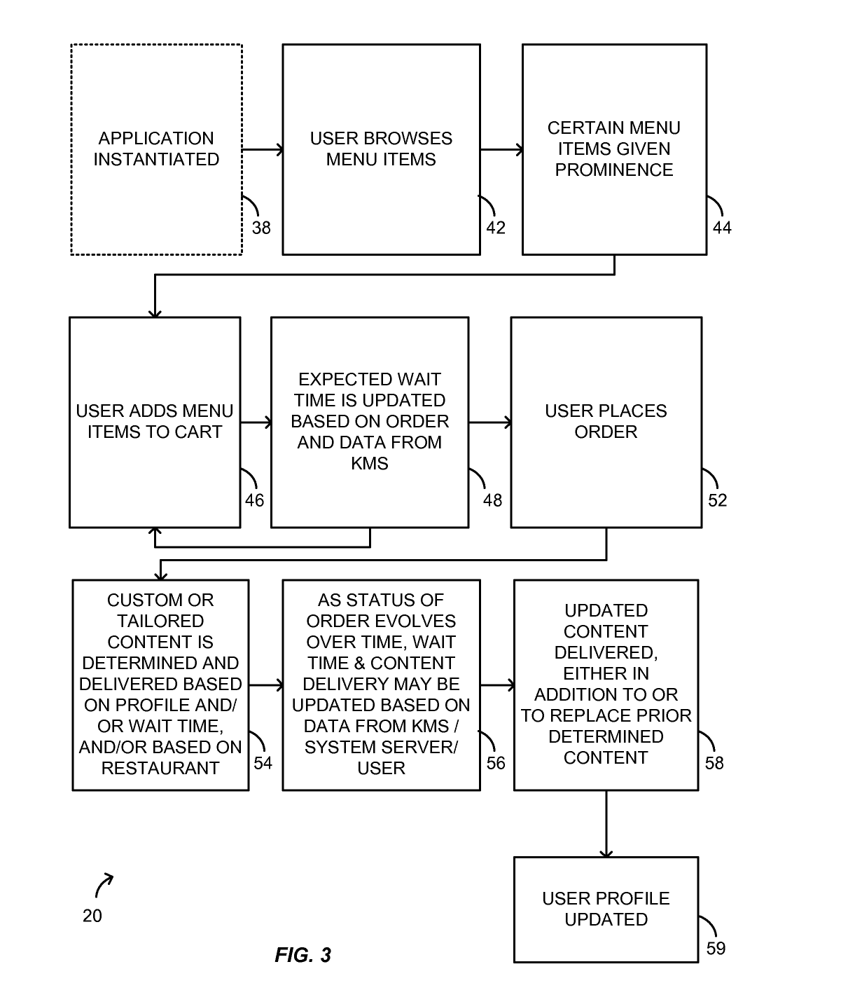

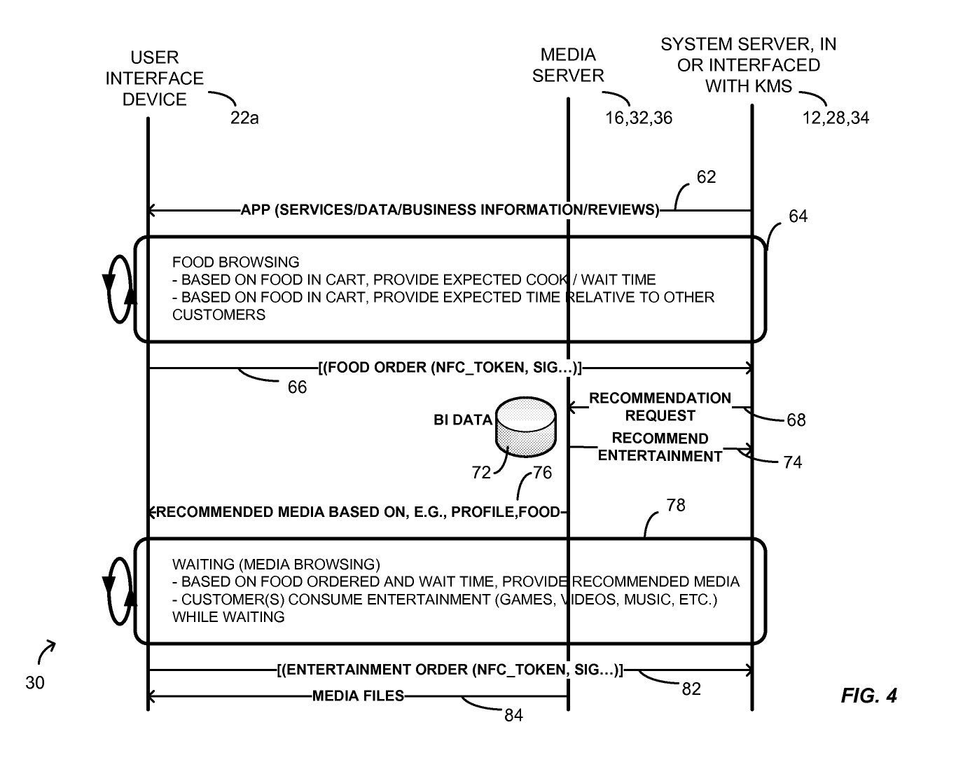

Referring to the flowchart 20 of FIG. 3 and the sequence diagram 30 of FIG. 4, if the CE device is one provided by the restaurant, an appropriate application for ordering and potential content selection and/or delivery may be already provided and automatically running. Where users employ their own smart phones, an application on the smart phone, which may be a generic restaurant-ordering application, or one specific to the restaurant, allows the user to browse and order menu items. Such applications may be downloaded from various services prior to use.

A first step is that the application is instantiated (step 38). The application may be instantiated by the user in a normal fashion or the same may be automatically instantiated in the case where a user “checks in” at an establishment, e.g., on a social networking site or using a separate application. The application may in some cases run within the social networking site. Where a social network is employed, an establishment that is monitoring the check ins, subject to the privacy settings of the user for the social networking site, may be made aware of a user profile corresponding to a user having checked in to the establishment, and may tailor menu offerings to the user accordingly. Such may even be employed to seat users, e.g., particularly where users are disabled or have strict dietary requirements, e.g., an extreme reaction to exposure to gluten.

The application allows a user to browse menu items (step 42). Each user may employ their own CE device, or a group of users may employ one or more common CE devices.

Certain menu items may be recommended and placed prominently on a user interface of the application based on the user's profile or device ID (step 44). For example, if the user has information stored in their profile indicating that they are a vegetarian, vegetarian entrées may be placed prominently on the user interface of the application, or menu items may be filtered to only include such entrées. In any case, the user browses the menu items and adds or removes menu items as desired (step 46). Expected wait times are displayed and/or updated (step 48).

The wait times displayed may have various levels of granularity. For example, one wait time may indicate the time required to cook the food, a second wait time may indicate a time delay before the chef can start cooking the food. It will be understood that such data may be entered in a number of forms. For example, the user can input an amount of time they have available before an order must be delivered. Alternatively, the user can input an amount of time available they have for the entire meal, which the system and method can then use in a calculation, estimating an amount of time required to eat the meal. In another alternative implementation, the user can indicate a time of day at which they must depart the establishment. The time available for the meal may then be calculated as the number of minutes between, e.g., the time of ordering, and the required time of departure.

Information such as additional chefs will impact the expected wait time, and can do so in real time. It is expected that wait time information may be obtainable for use by the systems and methods according to present principles given an appropriately-configured kitchen having a KMS. As a user continues to add items to be ordered, the expected wait times may be updated and transmitted to the corresponding CE device using, e.g., the NFC hotspot, so the user immediately knows how long their food will take, and can adjust their order accordingly if desired. There may be multiple communications between the CE or dedicated device and the KMS in this process as the user browses food items (see also step 64 of FIG. 4). In some implementations, the wait time may be updated based on data from third-party services. For example, if one of various social networking services that allow “check-ins” at an establishment indicates that a significant number of patrons just arrived at the establishment, such may tend to increase the wait time.

Once all the food items have been added to the order, such as by using a shopping cart, and the user is satisfied with the order, the user may then submit the order (step 52). When the food order is submitted, the expected wait time and device ID and profile may be communicated to a system server in communications with the media server, which may in turn recommend media to be returned while the user awaits the ordered food. The recommended media choices may be limited by the media that is available from the media content provider. From the available choices the system server may pick the content that is the best fit for the food the user ordered, the user's personal music preferences or history, the “atmosphere” or “character” of the restaurant the user is in, and in some cases even other factors such as the time of day. The recommended media may be immediately delivered or the user may be given a choice of various determined media content to receive (step 54). In this case, the user selects from among the recommended choices and the selected content is delivered. In the delivery, generally the system server transmits a signal that causes the media server to deliver the content to the client device, or to a communal device, although in some cases the system server may have local media stored for such delivery.

As time goes on, and food orders are completed and/or delivered according to the KMS, it may be that originally-determined content may no longer be suitable or may be better replaced with other updated content. In addition, as additional information becomes available from the KMS, e.g., the status of a food order is updated, the wait time may change and such may also affect recommended content. Accordingly, the content delivery may be updated based on data from the system server or KMS (step 56). This step may also occur where data from the user or another patron causes the user profile to change, e.g., even if just temporarily: for example, the user may decide that they do not wish to see a particular genre of movie trailer on the day they are patronizing the establishment, and such may be thus considered in the selection of content delivered to their CE device or other dedicated device.

Once the user has consumed the media content, the information about the consumed media, as well as about the ordered food, may be added to their profile or device ID and thus updates a food-to-media-preference relationship (step 59). The user may also indicate a level of satisfaction with the food, as well as an indication as to whether they would order the entrée again. Similarly, the user may rate the entertainment content. Such information may also be used in the updating of the profile.

Referring particularly to the sequence diagram 30 of FIG. 4, a CE device is shown as a user interface device 22a, and the same communicates with a system server, either within or interfaced with a KMS as depicted in elements 12, 28, and 34. The user interface device and system server also communicate with the media server, as depicted in elements 16, 32, and 36. The media server, as noted, may be local to the restaurant or disposed at a network-accessible location.

In a first step, an application is delivered to the user interface device 22a from the system server (step 62). The application may include not only browsing and ordering functionality but may also provide other services and data such as restaurant reviews and/or reviews of individual food items. The user then performs a step of food browsing (step 64). The food browsing may include reviewing the various menu choices and selecting items to be placed in a shopping cart within the application. Based on the contents of the cart, the system server and/or the KMS can return to the user interface device 22a an expected cooking/waiting time. Generally the waiting time returned will be indicative of the amount of time necessary for the user's order to arrive at the table. The waiting time may be updated until the order is fulfilled.

Once the user is satisfied with the items in their shopping cart, the food order is submitted (step 66). Given the estimate of wait time, as well as other data which may be employed, as described in greater detail below, custom or tailored entertainment may be provided to the user, either via their own CE device or via a communal display. To determine what entertainment to provide, or to recommend to the users for their selection, the recommendation request may be sent from the system server to the media server, and the media server may employ various business information data 72 in making the recommendation of entertainment (step 74) to the system server, which can then return the recommendations, including samples or trailers, to the CE device (step 76).

While the user is waiting for their order to arrive, e.g., during the predicted wait time, the user may browse the recommended media, and several communications back and forth may occur where a user reviews media choices, eventually settling on one or more to select. The content choices may be updated as the waiting time decreases or as the waiting time is updated by the KMS or system server. Once a selection is made, the entertainment order is sent from the CE device to the system server (step 80) and media files are delivered from the media server to the CE device (step 84).

In an alternative implementation, the media may be provided directly and immediately, without providing recommendations and without allowing for user choice.

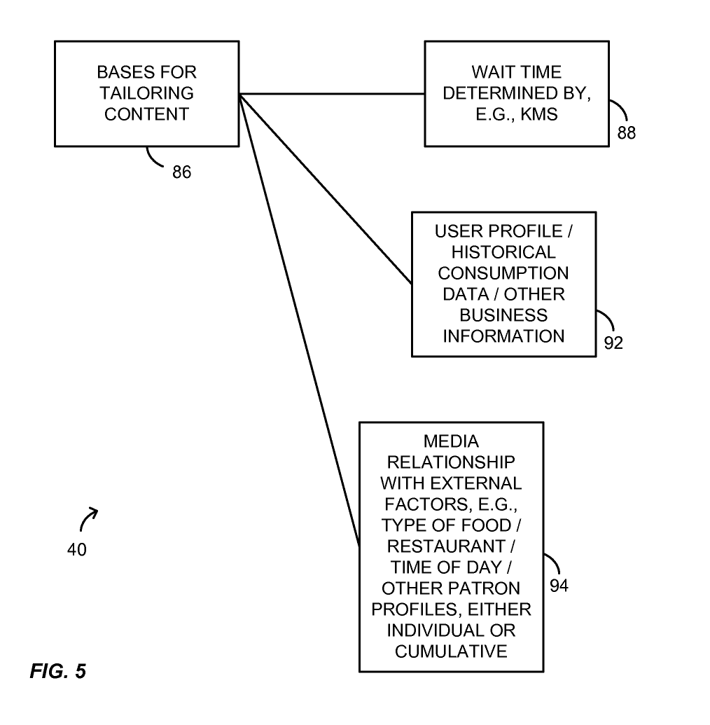

Referring to the flowchart 40 of FIG. 5, the custom-tailored content may be based on at least one of the following three bases 86 or data points, or a subset thereof: the determined (as well as updated) wait time 88, a user's profile 92 that has been aggregated or built from the user's prior entertainment consumption, e.g., for that unique device ID (or consumption associated with the user's profile across multiple devices), and/or a media relationship 94 with the desired food or with the restaurant (e.g., family food suggests family-related movies, music, games, or images). The media recommendations do not necessarily need to be provided by the system that provides the actual media, although in the sequence diagram above, for simplicity, such are shown on the same server. User profile information, i.e., “business information”, may include anything the system knows about the user and the user's previous activities, e.g., feedback the user has made about particular media choices. The business information may also include aggregate information across all users of the system, including how other users have reacted to the food choices in situations the user is currently faced with. Business information may also include a profile of the restaurant. For example, perhaps in the particular restaurant a song is liked or disliked by patrons more than it is in other restaurants. In aggregate, such can be applied to likes and dislikes for types of music.

A system, media, or other server that provides entertainment or content according to the user profile or device ID may track historical data about prior consumption. Prior consumption may include prior check-ins at restaurants or other establishments, prior content purchased or watched, preferences if any for particular types of media (e.g., a user may like movies but may never play video games), and the like. Numerous types of data may thus be retrieved from content delivery services, social networks, and the like.

In a variation of such systems and methods, instead of playing media directly for a single user or a single table, the media recommendations made by the system may be played for the whole restaurant, or area of the restaurant. In such systems, TV 25 (FIG. 2) may be employed which is visible by several tables. As an example of other data on which to base recommendations, if several users order hot, spicy, or flaming dishes, then such may indicate that the patrons have a different overall mood than if the patrons order mainly salads or other cold foods. In one embodiment, the option to play the recommended (or another) music selection on the restaurant's jukebox can be selected by the user, adding the jukebox fee, if there is one, to the user's bill.

The check in of a user, by which the user's mobile device becomes associated with a particular restaurant, may be performed in a number of ways. NFC hotspots are one such way, as disclosed above, but a user may also check in using a third-party service or social networking site. Other ways include Bluetooth®, Wi-Fi, Zigbee®, an app that uses GPS for geolocation which then checks in over a mobile network, bar codes, a wired connection, and the like.

A user may initiate the check in, or the check in may automatically occur as a user is determined to have entered the restaurant using the means noted above. Of course, for these purposes, a check in need not be made public; so long as the system server can be made aware of the presence of the user in the restaurant, the same can provide recommended media once a wait time is predicted (or even in the absence of a wait time, if an average wait time is employed).

The content delivery may be through a mobile network, e.g., 3G, 4G, LTE, and the like, or via the system server, e.g., through the NFC interface, through a WiFi associated with the restaurant, Zigbee®, Bluetooth®, and the like. The system may employ for content delivery the same system employed by the user to check in at the restaurant, or a different network may be employed. Where the content delivery is in some way connected with the restaurant, e.g., from the system server, the restaurant may insert ads or the like for promotions. One benefit of having content delivery from local system and media servers is that the same may be able to sustain content delivery even when other networks are temporarily unavailable. While various types of communication protocols have been described, a significant benefit of NFC is that the same may be localized to a table, and thus allow communications to be specific to that table.e.g., a TV visible to that table may be controlled via communications from that table or may be controlled in the aggregate by the tables which can view the TV. In some cases, tables having no interest in the delivered content may indicate that they are indifferent to watching content. In such implementations, various audio cancellation techniques may be employed to minimize sound leakage to such tables.

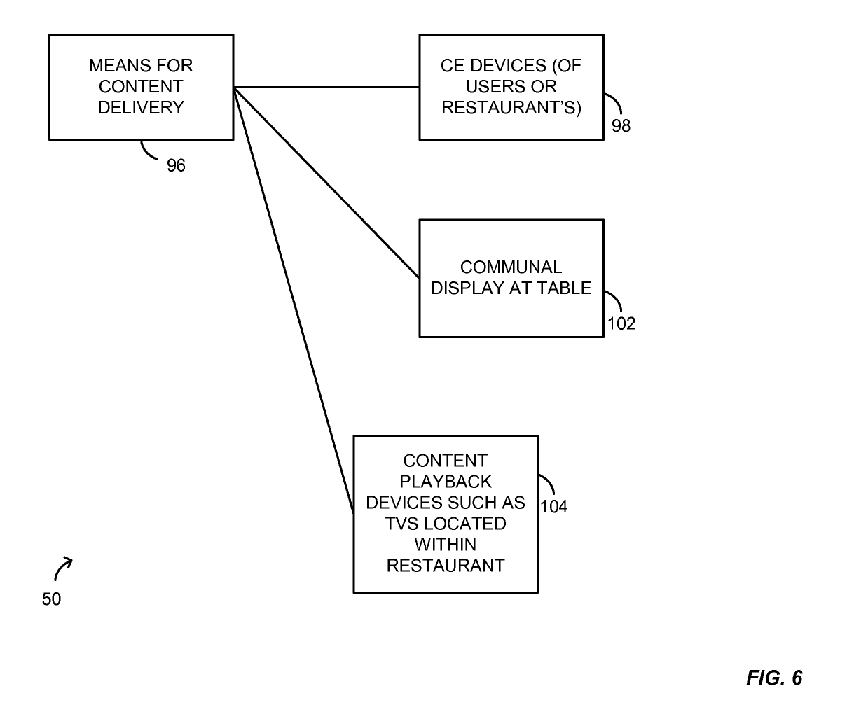

As noted above, and as indicated in the flowchart 50 of FIG. 6, the content delivery may be on one or more display means 96 including individual's mobile devices 98 or on a communal device 102, associated with the table. In the same way, a community touch pad may be employed, associated with a table, to allow joint or communal entry of commands, rather than from individual CE devices. Interesting forms of input may be created to take advantage of the communal aspect: a tap may indicate that users “like” a particular content item, and if the number of taps received equals the number of patrons at the table, it may be presumed that each user likes the content item. If less than all the patrons, it may be presumed that not everyone at the table likes the content item.

In another implementation, content may be delivered by tuning one or more televisions 104 to display a particular broadcast over the air, cable, or via satellite. In this case, the media server would generally need information about what channels are available and may also need information about those channels' programming schedules to know what the channels are currently showing. In one example, checking into a booth would cause the TV next to the booth to automatically tune to the game featuring the user's favorite team, if such was currently being broadcast. Similarly, users may browse through available broadcasts, sorted based on their interests as indicated in a user profile, as well as being based on how the broadcast timings line up with the expected or predicted wait times.

Updating of user profiles in such community cases may be in a number of ways, e.g., as if a single patron indicated interest, or a weighting may be applied to take account of the fact that communal interests may not necessarily equate to individual interests. It will be understood that variations of this concept may be implemented, e.g., multiple taps from a single user (indicated by occurring at or near a single point) may indicate significant, additional, or extra interest from that user (or from at least one user) in the given content item. In this regard it is noted that user localization may occur by identifying a CE device by which NFC hotspots it communicates with. Ratings may thus be provided by users on content items, and such feedback may be positive or negative, the feedback potentially informing future content choices delivered. One benefit to such communal touchpads is that such may be easier to operate than requiring users to retrieve their mobile devices, turn them on, activate an application, etc. Such may also increase community involvement.

As the media is being consumed, the expected wait time may be updated, e.g., the time may go down as dishes near completion, the time may go up if an error is made in the kitchen and chef has to redo a dish, and the like. Media content may be adjusted accordingly.

Other variations of the above systems and methods will be understood, and exemplary ones are described below.

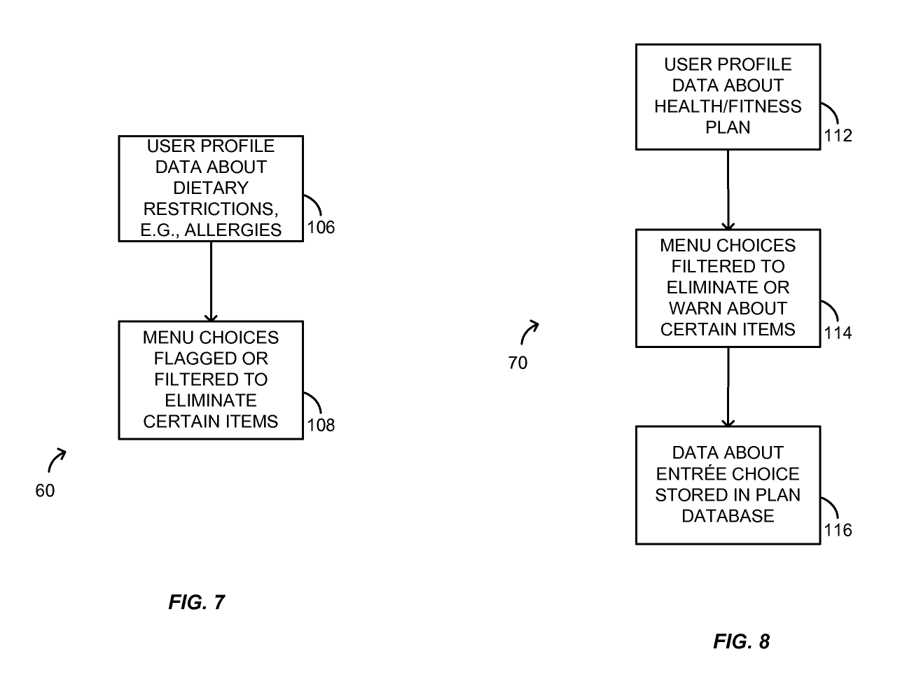

Referring to the flowchart 60 of FIG. 7, in one variation, data in a user's profile may be employed (step 106) as a user orders food to ensure that the user does not order an entrée with an ingredient to which they are allergic or for which they otherwise wish to avoid. For example, a user's profile may include information about a peanut allergy, and if an entrée has a database entry indicating peanuts as an ingredient, the database entry may cause an alert on a user interface of the mobile device application, warning the user against ordering the entrée, or the choices may be eliminated from the menu presented to the user on the UI of the CE device (step 108). Warnings may also be set to occur upon adding the item to a cart. Other variations will also be seen.

In another variation, systems and methods according to present principles may also incorporate other information in a user profile, such as for health or exercise monitoring. For example, the user profile and appropriate software applications may keep track of calories ingested, as well as in some cases calories expended, e.g., by GPS monitoring or via, e.g., functionality within application monitoring, e.g., a pedometer or a Sony® Playstation Move® game controller. In this way, the system and method can help users maintain health and fitness goals. In another implementation, if a large lunch has been determined by a user to create lethargy in the afternoon, the system and method may provide a warning of such upon the ordering of such or similar entrées.

In one such implementation, as shown in the flowchart 70 of FIG. 8, a user profile data may include information about health or fitness plan a user is intending to follow (step 112). Menu choices may then be filtered to eliminate or to warn about certain items (step 114), so as to eliminate, e.g., high calorie entrées. As many health or fitness plans include a requirement or suggestion to monitor calories of intake, data about the entrée choice eventually made may be stored in a plan database following the order (step 116).

Referring back to step 94 of FIG. 5, systems and methods according to present principles may also provide tailored media not just according to the type of food, but also according to the type of restaurant. For example, a fine dining establishment may cause a preference for classical music in recommended media, while a raucous diner-type establishment may cause a preference for louder pop or rock music.

In a further variation according to present principles, media from adjacent tables may be coordinated. For example, if a particular piece of music is deemed appropriate for delivery by two adjacent tables, not only the same music but also the same point of synchronization within the music may be employed to provide a pleasing effect for each table. Alternatively, as mentioned above, audio cancellation techniques may be employed to minimize content leakage from table-to-table.

In yet another variation, delivered video content need not be tied directly with audio content. For example, instead of showing scenes from an Italian movie in an Italian restaurant, Italian music may be delivered while scenes of famous locations in Italy may be rendered in still photographs on the display. Advertising may also be delivered, either in audio or video form. The advertising may be tied to user profiles, e.g., if it is known that certain patrons rarely order dessert, advertisements for desserts directed towards that patron may be omitted. If certain patrons are known to prefer high-end wines, advertisements for such may be preferentially delivered to such patrons.

In yet another variation, the content is tailored to the wait time but the wait time is determined by when the wait staff takes and inputs the order, i.e., in the conventional way, rather than having the order input by patrons using their mobile devices. To obtain wait time estimates, a KMS system is still required in such implementations. In yet another variation, besides basing media content on wait time, such may also be based on how long the ordered food choices typically take to eat, either using default values or those constructed based on compiled user data, particularly if the application has functionality for entering when food is ordered, when the food is delivered, etc. for example, buttons may be provided on the user interface to allow the user to track when they arrive at a restaurant, is seated, places an order, receives the order, and leaves, and such may provide valuable information for the user upon their return to the same restaurant.

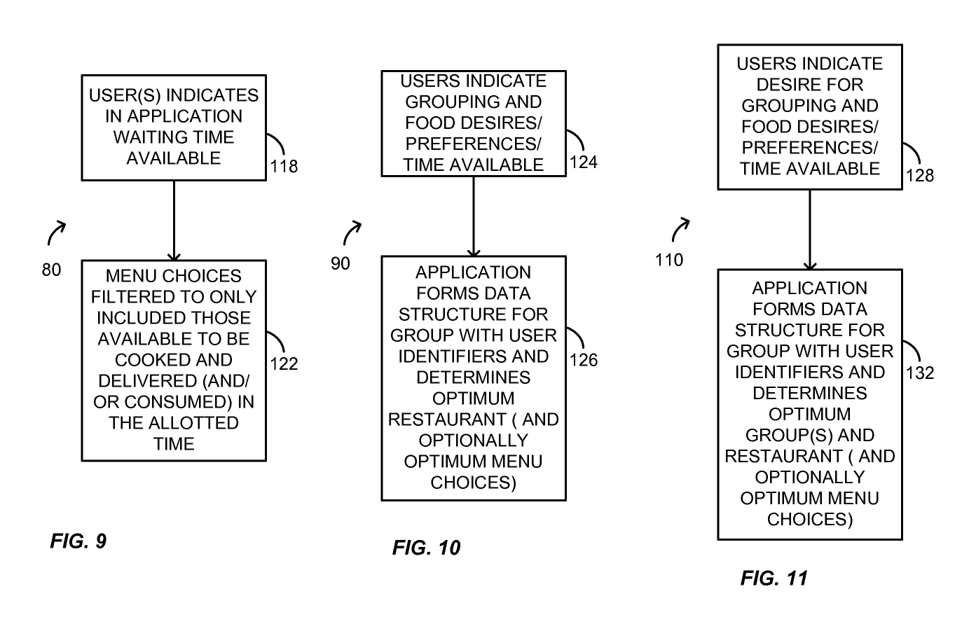

In another variation of the system and method according to present principles, and as seen in the flowchart 80 of FIG. 9, a user or group of users may indicate, e.g., in the application or to the wait staff (to enter in the KMS), the amount of time available (step 118), and the application may filter the displayed menu entrées according to those available to be cooked and delivered in the allotted time. Such may generally require an estimate of the amount of time required to consume the entrée, although a default value may also be employed, e.g., 30 min, or such values may be determined as averages based on historical data as noted above. The information may also be limited to the time required for food to be delivered. In other words, the user can indicate if the “available waiting time” pertains to the total time available for the meal or the time available just for meal delivery. Once such information is provided, the menu choices on the application may be filtered to only those available to be cooked and delivered in the allotted time (step 122).

In another such variation according to present principles, and referring to the flowchart 90 of FIG. 10, a group of people going to a restaurant may be coordinated within the central server as a group, e.g., by being associated within a data structure representing the group by suitable user identifiers, and may indicate their food or restaurant desires for the meal (preferences) as well as their available waiting time for the meal (step 124). The application may already have profile information associated with one or more users, e.g., dietary restrictions and goals if entered, etc. Given the group of users, their food or restaurant preferences, their user profiles, and their available wait times, the application may search for restaurants consistent with the given data (step 126). For example, if the only commonality in restaurant preferences (or within user profiles) within the group is that all users like Italian food, then Italian restaurants will be given priority in suggestions of restaurant establishments. In the same way, if some users in the group require a gluten-free diet, an establishment consistent with the user profiles would be one with at least some gluten-free offerings. Certain tolerances may be allowed on the user profiles, preferences, or other variables to allow for imperfect matches, e.g., perhaps a user would be willing to eat That or Indian food on a given day, and may indicate so in a preference field. User profiles may include certain “hard” data, such as a user's requirement to eat gluten-free food, as well as certain “soft” data, such as a preference for Italian or That food on a given day. User profiles defined in this way may change in some aspects from day to day. A user profile tolerance may be formed in hard data if the user profile indicates that the user in general likes foods of a given set of types. But a user profile tolerance may also be formed in soft data if the user indicates a preference for eating either Greek or Italian food on a given day. In the same way, a maximum waiting time may have a tolerance for a given user, or a tolerance may be provided by default by the application, e.g., +/−10 minutes.

In some implementations, systems and methods according to present principles may suggest food items for individual users, based on the input data. While generally the “available waiting time” variable will be set by the user with the least such time available, some implementations will allow users to indicate on the application if they are willing to depart the restaurant before the rest of the group, or after the rest of the group, and thus decouple their waiting time from that of the remainder. In any case, the system generally receives a maximum wait time from at least one member of the group. Once the group is at the restaurant, content may be delivered as noted above based on the total time available (if the group were to start consuming content upon arrival at the establishment, in some cases necessitating pre-order of menu items), or based on the waiting time following order placement.

Referring to the flowchart 110 of FIG. 11, the system and method according to present principles may even create groups, e.g., from a large number of co-workers, based on indications by individual users of the same factors noted above, as well as a willingness to be grouped with others of similar preferences. In such systems, a first step is that users indicate their desire or availability for grouping as well as food/restaurant preferences (step 128). The application may then determine the optimum group or groups given the set of individual users and their preferences/profiles, as well as their available waiting times and/or times available for the entire meal. The remainder of the method is similar to that of FIG. 10 above.

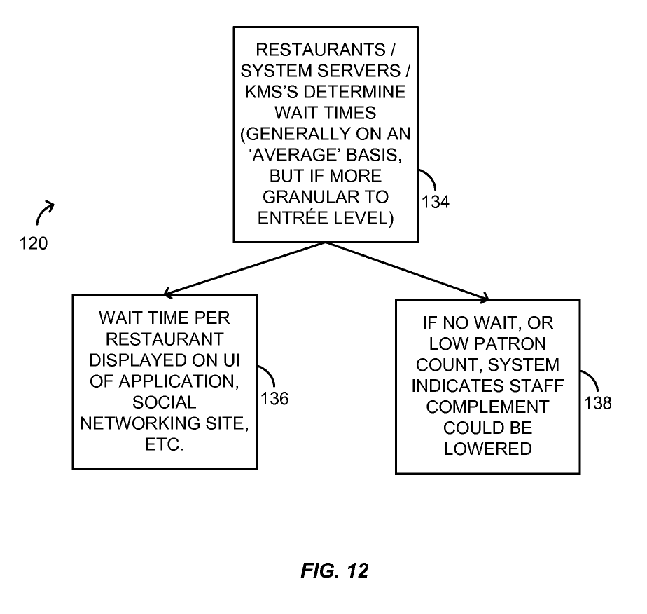

In yet a further such variation, and referring to the flowchart 120 of FIG. 12, systems and methods according to present principles may be extended to allow predictions of required resources and wait times by restaurants and users, respectively. For example, if the KMS or system server indicates (step 134) a restaurant is at capacity and has a wait list, such could be portrayed on the application or on a social networking or other service (step 136), to let users know of the significant wait. Wait times could be portrayed on a map or other appropriate user interface metaphor or feature. Of course, availability could also be so noted, e.g., by green icons as opposed to red icons. The wait times portrayed could be for obtaining a table and/or, e.g., for obtaining a specific dish or a specific table, if the user has entered such in the application or the application offers such information. In the same way, if the KMS indicates there are currently few users, and if, e.g., an algorithm or external data predicts few patrons are likely to appear for the remainder of the day, then the manager of the restaurant may be enabled to send a chef and some of the wait staff home, increasing efficiency (step 138). Such may also be employed to control break times, so as to avoid having significant numbers of staff out on breaks during rush times.

The systems and methods according to present principles may be implemented in any automated food ordering system where a menu is accessed electronically and can be updated in near real-time. Such may include orders placed at kiosks or orders placed through a touchscreen built into booths at a restaurant.

As noted above, the system generally employs a kitchen management system which can provide an estimate of wait time given one or more ordered food items. Wait time may be based on many factors, many of which can be predicted fairly accurately. Different dishes take different times to cook. There can be contention for specific resources in the kitchen. If a certain dish requires cooking in a fryer or other device that can only be used for one dish at a time, a dish may end up being queued behind other dishes that require cooking in the same appliance. Such can be predicted as the capacity for each cooking appliance can be known in advance, as well as the cooking appliance utilization for each dish, and finally the queue of orders already in the system requiring the appliance can be known.

Algorithms employed by kitchen management system may take many forms, and an exemplary one is indicated by the flowchart 140 of FIG. 13. In general it is noted that:

T_{wait time}=f({ordered items}, {other items undergoing preparation}, {complement of kitchen staff}) (1)

Various boundary conditions can be known and applied in the determination of a solution. For example, if there are no other items undergoing preparation, and the complement of kitchen staff is sufficient to prepare all ordered items simultaneously or in parallel, then the wait time is just the longest preparation time for an individual item:

T_{wait time}(no other items being prepared,sufficient kitchen staff)=Tₚᵣₑₚ(longest preparation time item) (2)

For example, if a table orders a pizza and a salad, the wait time will be the preparation time for the pizza.

On the other hand, if each item ordered requires a common device for its preparation, and the establishment only has one such device, then the wait time will be the sum of the individual wait times, as the preparation must occur serially. For example, if each user at the table orders pizza, and the establishment has a pizza oven that can only cook one pizza at a time, then the preparation time will be the sum of the individual pizza preparation times:

T_{wait time}(each item requires common device,sufficient kitchen staff)=ΣTiₚᵣₑₚ (3)

Of course, if the common device can accommodate multiple items, the waiting time will decrease accordingly.

Where the complement of kitchen staff is limited, an approximation for equation (1) above may in some implementations be obtained by adding an additional term representing the preparation of other food items to the wait time calculated for the particular or subject table. For example:

T_{wait time}=f({ordered items},{complement of kitchen staff})+f({other items undergoing preparation}, {complement of kitchen staff}) (4)

This may be further expanded to:

T_{wait time}^{total}=max {{Σᵢ₌₁^{N}^{ᵢ}T_{Wait time}^{individual,common device}},{T_{wait time}^{individual,non-common device}}}+Tₚᵣₑₚₐᵣₑᵣ^{other items} (5)

Which is also an approximation but which indicates that the total wait time may be estimated as the maximum of the wait times for individual items prepared without common devices and the wait times for items prepared with common devices (entailing serial preparation), added to which is the time required for a preparer to start on the table's items, given other items they are currently working on. Equation (5) is still an approximation in part because:

Tₚᵣₑₚₐᵣₑᵣ^{other items}=f(T_{wait time}^{individual,common device},T_{wait time}^{individual,non-common device},kitchen staff) (6)

However, in practice with a given menu and a given complement of kitchen staff, enough boundary conditions generally become known to allow one of ordinary skill in the art to quickly solve the linked equations numerically, allowing accurate estimates of wait times to be predicted.

For example, and referring to FIG. 13, a flowchart 140 is illustrated which generally describes one implementation of an algorithm employable by a kitchen management system to calculate or estimate predicted wait times. In a first step, a user browses menu items in a similar fashion as noted above (step 101). The kitchen management system receives the order, either as a final submission or while the order is being prepared by the user, e.g., by browsing the menu and adding menu items to a shopping cart (step 103). As the user adds items to the shopping cart or deletes them, the waiting time may be calculated and updated, in e.g., the manner described below. In this way, e.g., the user can tailor the waiting time to the time available.

The order is analyzed by the kitchen management system (step 105). The analysis may include, e.g., separating out items that require a common cooking device, and in particular where the device can only cook one item at a time. If the device can cook multiple items simultaneously, such is factored into the analysis. In the same way, if an item ordered requires significant amounts of the preparer's personal attention, such may also be factored into the analysis. For example, certain cream-based sauces require constant stirring, thus requiring constant attention, in contrast to placing a steak on a grill, which does not require any attention until the time comes to flip the steak.

The order may also be analyzed to determine the complement of kitchen staff required (step 107). This step may be particularly relevant where items requiring significant personal attention are ordered. This step may also be important in cases where the kitchen is not at full staff, or where a restaurant is at overflow capacity. Conversely, the step may be less important in cases where the kitchen is at full staff and the kitchen management system has based the estimates of individual waiting times on a fully-staffed kitchen.

The predicted wait time is then calculated, given the items in the shopping cart and the staff/equipment required (step 109). The wait time is then delivered to the client device (step 111). Once the users are satisfied with the order, the order is submitted (step 117) and preparation of the order begins.

As noted above, the status of the order may evolve over time, as orders started prior to the subject table's order are completed and delivered. Accordingly, the wait time may be updated based on updated preparation data (step 113). The updated wait time may then be delivered to the client device (step 115).

The system may be extended to provide the kitchen with guidance on next steps to be performed to prepare entrées in the most efficient manner, which is also what the system estimates may be based on. Such improves the efficiency of the kitchen and also the accuracy of the predicted wait times. For example, if an order arrives with one item having a long cooking time, the KMS can direct that the dish is started right away while other steps in completing that order are performed after orders that were placed before that table ordered.

Variations of the above-outlined principles may be apparent to one of ordinary skill in the art given this disclosure. Such variations may include applying the system and method to alternative applications, e.g., any service establishment where users are queued and where services or goods are delivered over time, e.g., beauty salons, personal shopping, gas station kiosks, online environments, doctor's offices, government offices, and the like. In a particular variation, at a gas station kiosk, if a suitable ordering and content delivery application receives data indicating that a user has purchased a certain number of gallons of gasoline, and if the rate of delivery is known, dividing the former by the latter will give a “waiting time” on which content delivery may be based. It has been described that a user may select if a waiting time entered on their client device corresponds to a total time available for the meal, a time available between the conclusion of ordering and departure, or other such times as may be defined; in the same way, a user may indicate if the time available corresponds to when their own ordered item is delivered or when all of the ordered items of the subject table have been delivered, as well as other such variations. In another exemplary variation, the kitchen management system may include a user interface for user input of estimated wait times, e.g., by a host or maître d’. It will be understood that kitchen management systems may further employ a number of other techniques and systems in the prediction of wait times, e.g., expert systems, machine learning, neural nets, Bayesian analysis, and the like.

It is noted that while the system server treats the users as a group, e.g., as a grouped data structure, the users at a subject table may order using their own client CE devices or the table may order on just one such device, or on a communal device, or on a combination of the above. In the same way, different tailored content may be delivered to different user devices.

In an exemplary variation on the server logical layout, the server hosting the business information data to make recommendations is also the server that hosts the review data that the recommendations will be based on. However, the recommendations may also come from separate servers in alternative implementations. Besides media and system servers, other servers may be employed for content recommendation and delivery, entertainment media and food reviews, and the like.

What has been described are systems and methods for enhancing a user experience while undergoing a waiting time, especially where the waiting time is predictable and where content can be tailored to the user and delivered.

One implementation includes one or more programmable processors and corresponding computer system components to store and execute computer instructions and data, such as to provide the structures, systems, and interfaces to allow application downloading, application instantiation, menu presentation on the user interface of the application, item selection, calculation and display of waiting times, content delivery, and the like. One such computing environment is disclosed below.

Referring to FIG. 13, a representation of an exemplary computing environment 130 in which the system and method may be implemented is illustrated.

The computing environment 130 includes a controller 142, a memory 146, storage 152, a media device 156, a user interface 164, an input/output (I/O) interface 166, and a network interface 168. The components are interconnected by a common bus 172. Alternatively, different connection configurations can be used, such as a star pattern with the controller at the center.

The controller 142 includes a programmable processor and controls the operation of various components of the system, such as a CE device, dedicated device, communal device, IPTV or other display, system server, kitchen management system, media server, or the like. The controller 142 loads instructions from the memory 146 or an embedded controller memory (not shown) and executes these instructions to control the system.

Memory 146, which may include non-transitory computer-readable memory 148, stores data temporarily for use by the other components of the system. In one implementation, the memory 146 is implemented as DRAM. In other implementations, the memory 146 also includes long-term or permanent memory, such as flash memory and/or ROM.

Storage 152, which may include non-transitory computer-readable memory 154, stores data temporarily or long-term for use by other components of the system, such as for storing data or instructions relating to menu creation and filtering, ordering, content selection, delivery, presentation, and the like. In one implementation, the storage 152 is a hard disc drive or a solid state drive.

The media device 156, which may include non-transitory computer-readable memory 162, receives removable media and reads and/or writes data to the inserted media. In one implementation, the media device 156 is an optical disc drive or disc burner, e.g., a writable Blu-ray® disc drive 158.

The user interface 164 includes components for accepting user input, e.g., the user indication of food items, waiting times, or other aspects discussed above, and presenting a display, e.g., a menu or predicted wait time to the user, as well as for displaying played-back content items. In one implementation, the user interface 164 includes a touch screen or keyboard, an audio speaker, and a display. The controller 142 uses input from the user to adjust the operation of the computing environment.

The I/O interface 166 includes one or more I/O ports to connect to corresponding I/O devices, such as external storage or supplemental devices, e.g., a printer or a PDA. In one implementation, the ports of the I/O interface 166 include ports such as: USB ports, PCMCIA ports, serial ports, and/or parallel ports. In another implementation, the I/O interface 166 includes a wireless interface for wireless communication with external devices. These I/O interfaces may be employed to connect to one or more content playback devices.

The network interface 168 allows connections with the local network and includes a wired and/or wireless network connection, such as an RJ-45 or Ethernet connection or “Wi-Fi” interface (802.11). Numerous other types of network connections will be understood to be possible, including WiMax, 3G or 4G, 802.15 protocols, 802.16 protocols, satellite, Bluetooth®, or the like.

The system may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

The methods shown and described above may be implemented in one or more general, multi-purpose, or single-purpose processors. Unless specifically stated, the methods described herein are not constrained to a particular order or sequence. In addition, some of the described methods or elements thereof can occur or be performed concurrently.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

1. A method of providing tailored content to a customer during a waiting period, comprising:
a. from an application running on a device, the application associated with a user profile, receiving at a server a selection of a first menu item selected from a menu of an establishment;
b. from a kitchen management system associated with the establishment, receiving a wait time, the wait time corresponding to a time duration for a customer to receive the selected first menu item;
c. selecting at least one digital content item to deliver, the selecting based at least in part on the wait time and the user profile; and
d. transmitting a signal to cause the delivery of the selected digital content item to the device or to a communal device.

2. The method of claim 1, wherein the receiving a wait time includes submitting the first menu item to the kitchen management system and receiving a wait time in response to the submission.

3. The method of claim 1, wherein the kitchen management system forms a part of the server.

4. The method of claim 1, further comprising receiving notification of a check-in at the establishment, the check-in associated with the user profile.

5. The method of claim 4, wherein the notification is received from a social networking site.

6. The method of claim 4, wherein the menu displayed on a user interface of the application is filtered based on the user profile.

7. The method of claim 1, wherein the device is a CE device or a dedicated device.

8. The method of claim 1, wherein the menu displayed on a user interface of the application is filtered based on the user profile.

9. The method of claim 1, wherein the selecting is further based on a profile associated with the establishment.

10. The method of claim 1, further comprising transmitting the received wait time to the device.

11. The method of claim 10, further comprising transmitting an updated wait time as additional information from the kitchen management system is received about a status of the first menu item, and selecting at least one additional digital content item to transmit a signal to cause the delivery of, the selecting based at least in part on the updated wait time and the user profile.

12. The method of claim 1, wherein the receiving at a server includes receiving the selection of the first menu item from the device via a near field communications hotspot disposed adjacent the device.

13. The method of claim 1, wherein the selecting is further based on a departure time, the departure time entered by the user.

14. The method of claim 1, further comprising receiving at the server a selection of a plurality of menu items selected from a menu of an establishment, and wherein the wait time corresponds to a time duration for both the selected first menu item and the plurality of selected menu items to be received by customers.

15. A non-transitory computer readable medium, comprising instructions for causing a computing environment to perform the method of claim 1.

16. A method of determining an establishment for a group of customers to patronize, comprising:
a. in an application running on a server, receiving a signal from one or more users operating client devices that a user group is to be formed, and forming a data structure representing the group including an identifier from each user in the group, each user in the group having a respective user profile, whereby the group represents users desiring to patronize an establishment together;
b. receiving from the client device of at least one user in the group a maximum wait time; and
c. from at least one user profile and from the maximum wait time, determining an establishment for the group the patronize, the establishment having an establishment wait time less than the maximum wait time, and the establishment consistent with each user profile within the group.

17. The method of claim 16, further comprising:
a. receiving at a server a selection of a first menu item selected from a menu of an establishment;
b. from a kitchen management system associated with the establishment, receiving a wait time, the wait time corresponding to a time duration for a customer to receive the selected first menu item;
c. selecting at least one digital content item to deliver, the selecting based at least in part on the wait time; and
d. transmitting a signal to cause the delivery of the selected digital content item to at least one of the client devices of the users in the group, or to a communal device.

18. The method of claim 16, further comprising receiving from a plurality of users in the group a maximum wait time, and wherein the determining an establishment for the group to patronize includes determining an establishment with an establishment wait time less than a least maximum wait time received from the plurality.

19. A non-transitory computer readable medium, comprising instructions for causing a computing environment to perform the method of claim 16.

20. A method of determining a group of users and selecting a content item appropriate therefore, comprising:
a. on an application running on a server, receiving from a plurality of users a maximum wait time, each user further associated with a user profile accessible to the application;
b. selecting a group of users from the plurality, the group having a common maximum wait time, within a wait time tolerance; and
c. determining an establishment for the group the patronize, the establishment having a wait time less than the common maximum wait time of the group, and the establishment consistent with each user profile within the group.

21. The method of claim 20, further comprising:
a. receiving at a server a selection of a first menu item selected from a menu of an establishment;
b. from a kitchen management system associated with the establishment, receiving a wait time, the wait time corresponding to a time duration for a customer to receive the selected first menu item;
c. selecting at least one digital content item to deliver, the selecting based at least in part on the wait time; and
d. transmitting a signal to cause the delivery of the selected digital content item to at least one of the client devices of the users in the group, or to a communal device.

22. A non-transitory computer readable medium, comprising instructions for causing a computing environment to perform the method of claim 20.
